(19) United States
(12) Patent Application Publication
(10) Pub. No.: US 2013/0111101 A1
(43) Pub. Date: May 2, 2013

(54) SEMICONDUCTOR MEMORY DEVICE AND OPERATING METHOD THEREOF

(71) Applicant: Seok-Cheol YOON, Gyeonggi-do (KR)

(72) Inventor: Seok-Cheol YOON, Gyeonggi-do (KR)

(21) Appl. No.: 13/334,027

(22) Filed: Dec. 21, 2011

(30) Foreign Application Priority Data
Oct. 27, 2011 (KR) 10-2011-0110468

(51) Int. Cl. G06F 12/06

(52) U.S. Cl. 711/5; 711/E12.082

(57) ABSTRACT

A semiconductor memory device includes a path control unit configured to activate an address transmission path corresponding to a bank address, an address providing unit configured to provide a memory address to the path control unit in response to an active signal, and a plurality of memory banks each configured to receive the memory address provided through the corresponding address transmission path of the path control unit, wherein the bank address corresponds to a memory bank of the plurality of memory banks.

### CROSS-REFERENCE TO RELATED APPLICATIONS

The present application claims priority of Korean Patent Application No. 10-2011-0110468, filed on Oct. 27, 2011, which is incorporated herein by reference in its entirety.

### BACKGROUND

1. Field

Exemplary embodiments of the present invention relate to a semiconductor design technology, and more particularly, to a semiconductor memory device for performing a data access operation by receiving an address.

2. Description of the Related Art

In general, a semiconductor memory device such as a double data rate synchronous DRAM (DDR SDRAM) performs a data access operation by receiving an address and data, which are inputted from an external controller. More specifically, the semiconductor memory device stores data in a memory cell corresponding to an address in a write operation, and the semiconductor memory device outputs the data stored in the memory cell corresponding to the address in a read operation.

FIG. 1 is a block diagram illustrating a related art semiconductor memory device.

Referring to FIG. 1, the semiconductor memory device includes a delay unit 100, an address providing unit 110, a bank address decoding unit 120, first to fourth address latching units 130_1, 130_2, 130_3, and 130_4, and first to fourth memory banks 140_1, 140_2, 140_3, and 140_4. The delay unit 100 delays an active signal ACT to generate the delayed active signal D_ACT. The address providing unit 110 provides memory address signals ADD<1:15> to an address line L_ADD in response to the active signal ACT. The bank address decoding unit 120 decodes bank addresses BA<1:2> and outputs the decoded result as first to fourth enable signals EN<1:4> in response to the delayed active signal D_ACT. The first to fourth address latching units 130_1, 130_2, 130_3, and 130_4 latch addresses ADD_OUT<1:15> provided through the address line L_ADD and output the latched address signals in response to the respective first to fourth enable signals EN<1:4>. The first to fourth memory banks 140_1, 140_2, 140_3, and 140_4 receive output signals ADD_LAT1<1:15>, ADD_LAT2<1:15>, ADD_LAT3<1:15>, and ADD_LAT1<1:15> respectively inputted from the first to fourth address latching units 130_1, 130_2, 130_3 and 130_4 to perform a data access operation.

FIG. 2 is a circuit diagram illustrating the address providing unit 110 of FIG. 1. As described above, the address providing unit 110 is used to provide the memory address signals ADD<1:15> in response to the active signal ACT. A circuit corresponding to one bit of the 15-bits of the memory address signals ADD<1:15> is representatively illustrated in FIG. 2.

As described in FIGS. 1 and 2, the related art semiconductor memory device provides the memory address signals ADD<1:15> to the address line L_ADD in response to the active signal ACT, and the related art semiconductor memory device outputs the first to fourth enable signals EN<1:4> generated by decoding the bank address signals BA<1:2> in response to the delayed active signal D_ACT.

More specifically, the first to fourth memory banks 140_1, 140_2, 140_3, and 140_4 receive the memory address signals ADD<1:15> when the delayed active signal D_ACT is activated so that the first to fourth enable signals EN<1:4> are output from the bank address decoding unit 120. The first to fourth memory banks 140_1, 140_2, 140_3, and 140_4 receive the memory address signals ADD<1:15> and subsequently perform the data access operation. Thus, the time when the semiconductor memory device performs the data access operation is determined by a time when the delayed active signal D_ACT is activated.

Additionally, the first to fourth address latching units 130_1, 13_2, 130_3, and 130_4 output the output addresses ADD_OUT<1:15> of the address providing unit 110, which are inputted in response to an activated enable signal of the first to fourth enable signals EN<1:4>, to any one of the latched first to fourth address signals ADD_LAT1<1:15>, ADD_LAT2<1:15>, ADD_LAT3<1:15>, and ADD_LAT1<1:15>. More specifically, the address providing unit 110 provides the memory address signals ADD<1:15> to each of the first to fourth address latching units 130_1, 130_2, 130_3, and 130_4. However, if the fourth enable signal EN<4> is activated so that the fourth memory bank 140_4 is activated, the current used when the memory address signals ADD<1:15> are provided to the first to third memory banks 140_1, 140_2 and 140_3 is wasted current.

### SUMMARY

An embodiment of the present invention is directed to a semiconductor memory device including a bank address signal that is directly used to activate a path along which a memory address signal is provided.

In accordance with an embodiment of the present invention, a semiconductor memory device includes a path control unit configured to activate an address transmission path corresponding to a bank address; an address providing unit configured to provide a memory address to the path control unit in response to an active signal; and a plurality of memory banks each configured to receive the memory address provided through the corresponding address transmission path of the path control unit, wherein the bank address corresponds to a memory bank of the plurality of memory banks.

In accordance with another embodiment of the present invention, a semiconductor memory device includes a first memory bank configured to receive an address provided through a first address transmission line; a second memory bank configured to receive an address provided through a second address transmission line separate from the first address transmission line; an address providing unit configured to provide a memory address in response to an active signal; a first address output unit configured to output an output signal of the address providing unit to the first address transmission line in response to a bank address, wherein the bank address corresponds to a memory bank; and a second address output unit configured to output the output signal of the address providing unit to the second address transmission line in response to the bank address.

In accordance with yet another embodiment of the present invention, an operating method of a semiconductor memory device includes electrically connecting an address transmission path for providing a memory address to a selected memory bank; providing the memory address to the address transmission path in response to an active signal; and performing a data access operation in the selected memory bank in response to the memory address.

In accordance with still another embodiment of the present invention, a semiconductor memory device includes a path control unit configured to have a plurality of address transmission paths respectively corresponding to a number of bits of a bank address and activate one of the plurality of address transmission paths in response to the bank address; and a plurality of memory banks configured to receive a memory address provided through the activated address transmission path among the plurality of address transmission paths to perform a data access operation, wherein the bank address corresponds to a memory bank of the plurality of memory banks.

### BRIEF DESCRIPTION OF THE DRAWINGS

FIG. 1 is a block diagram illustrating a related art semiconductor memory device.

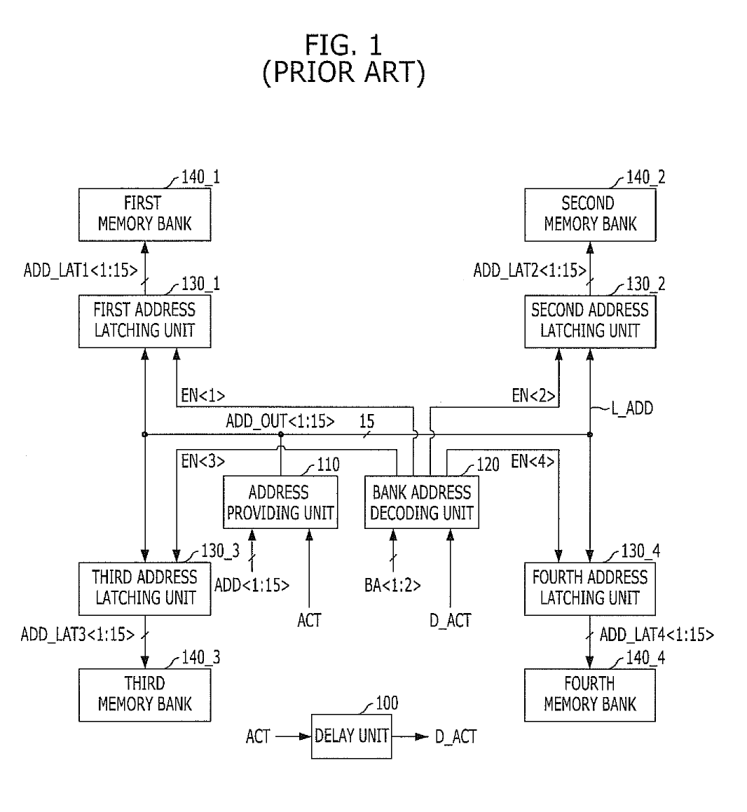

FIG. 2 is a circuit diagram illustrating an address providing unit of FIG. 1.

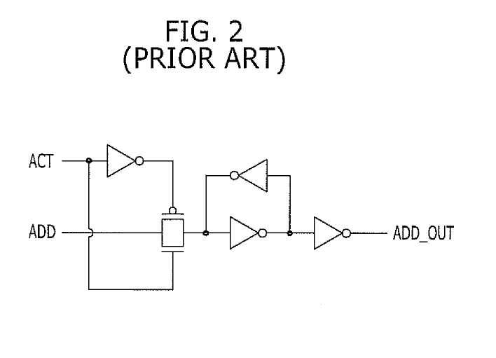

FIG. 3 is a block diagram illustrating a semiconductor memory device in accordance with an embodiment of the present invention.

FIG. 4 is a circuit diagram illustrating a configuration of an address providing unit and a central path control unit illustrated in FIG. 3.

FIG. 5 is a circuit diagram illustrating a configuration of a first path control unit of FIG. 3.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

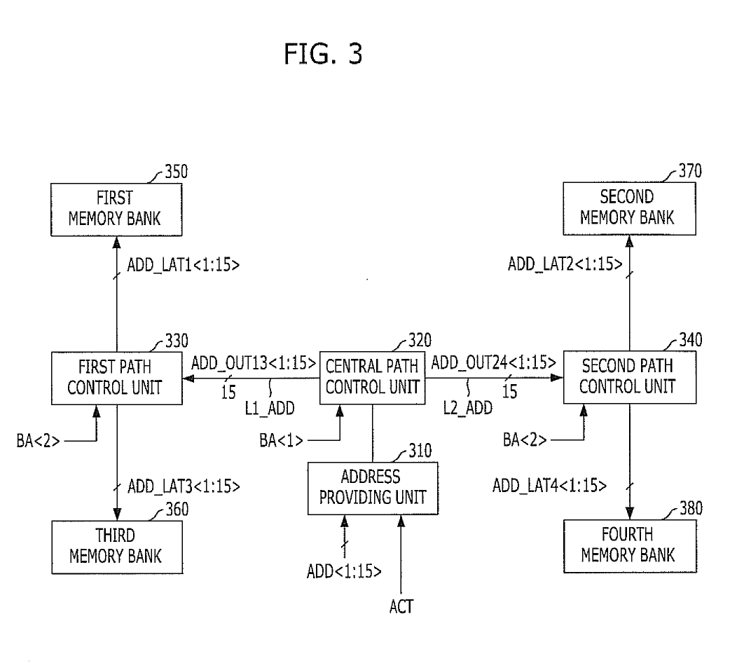

FIG. 3 is a block diagram illustrating a semiconductor memory device in accordance with an embodiment of the present invention.

Referring to FIG. 3, the semiconductor memory device includes an address providing unit 310, a central path control unit 320, first and second path control units 330 and 340, and first to fourth memory banks 350, 370, 360, and 380.

The address providing unit 310 provides memory address signals ADD<1:15> to the central path control unit 320 in response to an active signal ACT. The central path control unit 320 activates an address transmission path in response to a first bank address signal BA<1>, and the first and second path control units 330 and 340 activate an address transmission path in response to a second bank address signal BA<2>. As will be described later, the output signal of the address providing unit 310 is provided to a selected memory bank among the first to fourth memory banks 350, 360, 370, and 380 through an address transmission path activated by the first and second bank address signals BA<1:2> in the central path control unit 320 and the first and second path control units 330 and 340. Subsequently, the first to fourth memory banks 350, 360, 370, and 380 perform a data access operation in response to the memory address signals ADD<1:15> provided through the address transmission path.

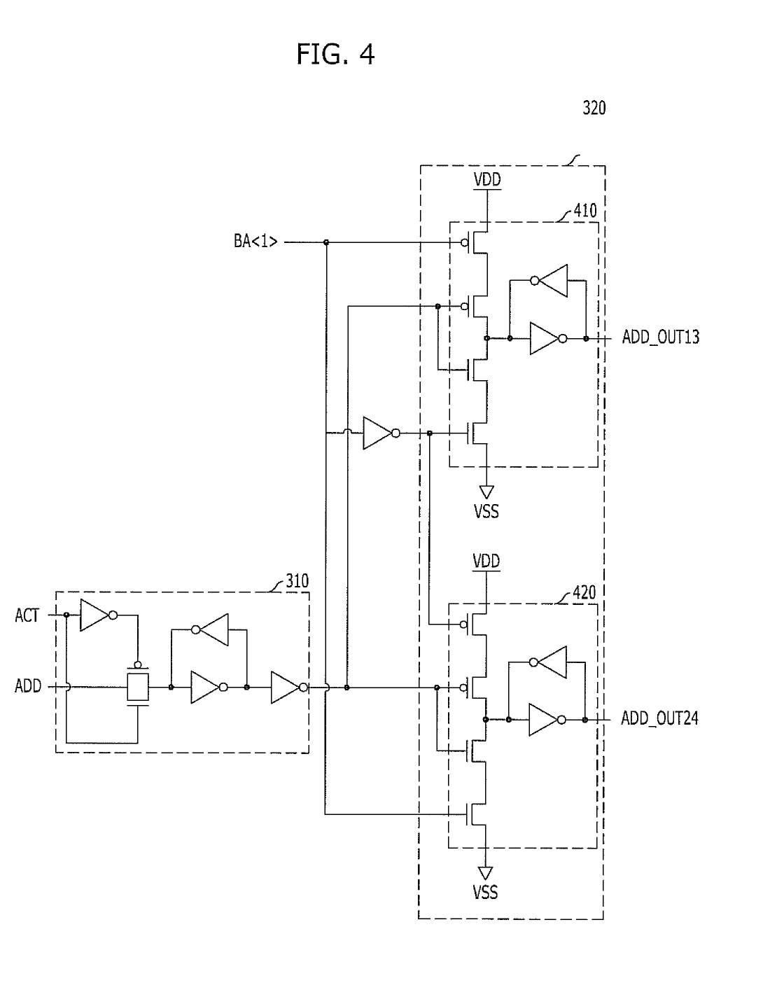

More specifically, the central path control unit 320 provides a first output address signal ADD_OUT13<1:15> to the first path control unit 330 through a first address transmission line L1_ADD, and the central path control unit 320 provides a second output address signal ADD_OUT24<1:15> to the second path control unit 340 through a second address transmission line L2_ADD. As will be described later in FIG. 4, the first and second address transmission lines L1_ADD and L2_ADD are separate transmission lines.

FIG. 4 is a circuit diagram illustrating a configuration of the address providing unit 310 and the central path control unit 320 illustrated in FIG. 3. For illustration purposes, a circuit corresponding to one bit of 15-bits of the memory address signals ADD<1:15> is representatively illustrated in FIG. 4.

Referring to FIG. 4, the address providing unit 310 receives a memory address signal ADD in response to the active signal ACT. Additionally, the central path control unit 320 has first and second address output units 410 and 420 for activating an address transmission path in response to the first bank address BA<1>. Here, the first address output unit 410 outputs the output signal of the address providing unit 310 as the first output address signal ADD_OUT13 to the first address transmission line L1_ADD when the first bank address signal BA<1> is in a logic ‘low’ state, and the second address output unit 420 outputs the output signal of the address providing unit 310 as the second output address signal ADD_OUT24 to the second address transmission line L2_ADD when the first bank address signal BA<1> is in a logic ‘high’ state.

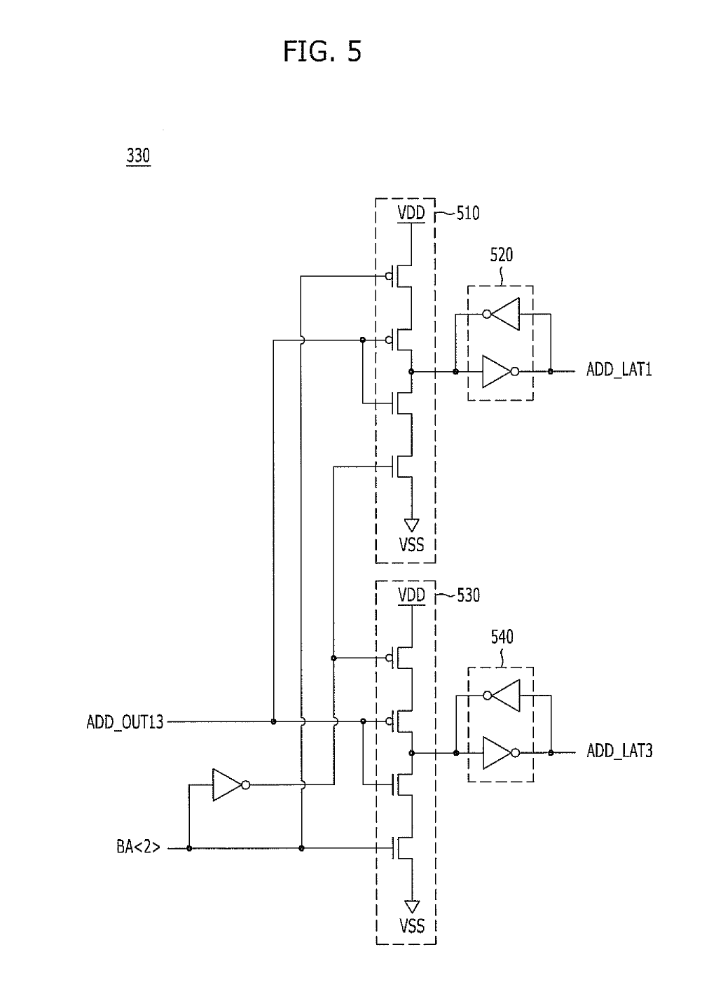

FIG. 5 is a circuit diagram illustrating a configuration of the first path control unit 330 of FIG. 3. The second path control unit 340 of FIG. 3 has a configuration similar to the first path control unit 330, and therefore, the first path control unit 330 will be representatively described.

Referring to FIG. 5, the first path control unit 330 includes first and second address output units 510 and 530 and first and second latching units 520 and 540. The first and second address output units 510 and 530 activate the address transmission path in response to the second bank address signal BA<2>. The first and second latching units 520 and 540 latch output signals of the first and second address output units 510 and 530.

Here, the first address output unit 510 outputs the first output address signal ADD_OUT13 to the first latching unit 520 when the second bank address signal BA<2> is in a logic ‘low’ state, and the first latching unit 520 latches the first output address signal and outputs the latched first output address signal as a first latched output address ADD_LAT1. The second address output unit 530 outputs the first output address signal ADD_OUT13 to the second latching unit 530 when the second bank address signal BA<2> is in a logic ‘high’ state, and the second latching unit 540 latches the first output address signal and outputs the latched first output address signal as a third latched output address ADD_LAT3. Referring back to FIG. 3, the first latched output address ADD_LAT1<1:15> is an address signal provided to the first memory bank 350, and the third latched output address ADD_LAT3<1:15> is an address signal provided to the third memory bank 360.

As can be seen in FIGS. 3 to 5, in the semiconductor memory device in accordance with the present invention, the address transmission path, along which the memory address signals ADD<1:15> are provided, is determined by the first and second bank address signals BA<1:2>. The address transmission path is activated at the time when the first and second bank address signals BA<1:2> are inputted. More specifically, the address transmission path corresponding to any one of the first to fourth memory banks 350, 370, 360, and 380 is electrically connected and activated by the first and second bank address signals BA<1:2>, and the memory address signals ADD<1:15> are provided to the selected memory bank through the activated address transmission path. In this embodiment, since address transmission paths respectively corresponding to the other memory banks other than the selected memory bank are not activated, the memory address signals ADD<1:15> are not transmitted to the other address transmission paths, and accordingly, additional current consumption does not occur.

The memory address signals ADD<1:15> provided by the address providing unit 310 in response to the active signal ACT are directly provided to a selected memory bank through an address transmission path corresponding to any one of the first to fourth memory banks 350, 370, 360, and 380 so that a data access time may be reduced.

As described above, in the semiconductor memory device in accordance with the embodiment of the present invention, the address transmission path along which the address signals ADD<1:15> are provided can be activated using the first and second bank address signals BA<1:2>. Accordingly, current consumption may be reduced and a faster data access time may be secured.

In accordance with the exemplary embodiments of the present invention, memory address signals are provided to an address transmission path corresponding to a selected memory bank using a bank address signal so that current consumption when the memory address signals are provided may be minimized.

Further, the memory address signals are directly inputted to a corresponding memory bank so that the time when a data access operation is performed may be reduced.

While the present invention has been described with respect to the specific embodiments, it will be apparent to those skilled in the art that various changes and modifications may be made without departing from the spirit and scope of the invention as defined in the following claims.

For example, the central path control unit 320 and the first and second path control units 330 and 340, illustrated in FIG. 3, in accordance with the embodiment of the present invention, have four address transmission paths corresponding to 2-bit bank address signals, and one of the four address transmission paths is activated. However, the present invention may include an embodiment where the central path control unit 320 and the first and second path control units 330 and 340 have a plurality of address transmission paths respectively corresponding to the number of bits of the bank address signals.

In addition, the positions and kinds of logic gates and transistors illustrated in the aforementioned embodiments may be differently implemented depending on the polarities of signals inputted thereto.

What is claimed is:

1. A semiconductor memory device comprising:
a path control unit configured to activate an address transmission path corresponding to a bank address;
an address providing unit configured to provide a memory address to the path control unit in response to an active signal; and
a plurality of memory banks each configured to receive the memory address provided through the corresponding address transmission path of the path control unit, wherein the bank address corresponds to a memory bank of the plurality of memory banks.

2. The semiconductor memory device of claim 1, wherein the address transmission path is configured to be activated at a time when the bank address is inputted.

3. The semiconductor memory device of claim 1, wherein the address transmission path is configured to be activated corresponding to each bit of the bank address.

4. A semiconductor memory device comprising:
a first memory bank configured to receive an address provided through a first address transmission line;
a second memory bank configured to receive an address provided through a second address transmission line separate from the first address transmission line;
an address providing unit configured to provide a memory address in response to an active signal;
a first address output unit configured to output an output signal of the address providing unit to the first address transmission line in response to a bank address, wherein the bank address corresponds to a memory bank; and
a second address output unit configured to output the output signal of the address providing unit to the second address transmission line in response to the bank address.

5. The semiconductor memory device of claim 4, wherein the first and second transmission lines are configured to be activated at a time when the bank address is inputted.

6. An operating method of a semiconductor memory device, the method comprising:
electrically connecting an address transmission path for providing a memory address to a selected memory bank;
providing the memory address to the address transmission path in response to an active signal; and
performing a data access operation in the selected memory bank in response to the memory address.

7. The method of claim 6, wherein the address transmission path is activated before the memory address is provided thereto.

8. A semiconductor memory device, comprising:
a path control unit configured to have a plurality of address transmission paths respectively corresponding to a number of bits of a bank address and activate one of the plurality of address transmission paths in response to the bank address; and
a plurality of memory banks configured to receive a memory address provided through the activated address transmission path among the plurality of address transmission paths to perform a data access operation, wherein the bank address corresponds to a memory bank of the plurality of memory banks.

9. The semiconductor memory device of claim 8, further comprising an address providing unit configured to provide the memory address to the path control unit in response to an active signal.

10. The semiconductor memory device of claim 8, wherein the address transmission path is configured to be activated at a time when the bank address is inputted.

11. A semiconductor memory device, comprising:
a plurality of first and second memory banks each configured to receive a memory address;
a central path control unit configured to activate a first or a second address transmission line in response to a first bank address signal;
a first path control unit connected to the first address transmission line and configured to activate a plurality of first address transmission paths respectively connected to the plurality of first memory banks in response to a second bank address signal;
a second path control unit connected to the second address transmission line and configured to activate a plurality of second address transmission paths respectively connected to the plurality of second memory banks in response to the second bank address signal; and
an address providing unit configured to provide the memory address to the path control unit in response to an active signal.
